(19) United States
(12) Patent Application Publication
(10) Pub. No.: US 2015/0098317 A1
(43) Pub. Date: Apr. 9, 2015

(54) LINEAR PROTECTION SWITCHING METHOD AND APPARATUS FOR PROTECTING NETWORK SEGMENTED INTO MULTI-DOMAIN

(71) Applicant: ELECTRONICS AND TELECOMMUNICATIONS RESEARCH INSTITUTE, Daejeon (KR)

(72) Inventors: Tae Sik CHEUNG, Daejeon (KR); Jeong Dong RYOO, Daejeon (KR); Dae Ub KIM, Daejeon (KR)

(21) Appl. No.: 14/507,056

(22) Filed: Oct. 6, 2014

(30) Foreign Application Priority Data
Oct. 7, 2013 (KR) 10-2013-0119134
Sep. 22, 2014 (KR) 10-2014-0125898

(51) Int. Cl. H04L 12/703; H04L 12/707

(52) U.S. Cl. CPC H04L 45/28; H04L 45/22
USPC 370/218

(57) ABSTRACT

Provided is a protection end node located at an end of a protection path, wherein the protection end node includes a receiver to receive, from a working end node located at an end of a working path, path defect information indicating whether a defect occurs on the working path, a processor to perform protection switching in response to reception of the path defect information and generate path control information used for the working end node to control a connection of the working path based on the protection switching, and a transmitter to transmit the path control information to the working end node.

### CROSS-REFERENCE TO RELATED APPLICATION

This application claims the priority benefit of Korean Patent Application No. 10-2013-0119134, filed on Oct. 7, 2013 and Korean Patent Application No. 10-2014-0125898, filed on Sep. 22, 2014 in the Korean Intellectual Property Office, the disclosure of which is incorporated herein by reference.

### BACKGROUND

1. Field of the Invention

The present invention relates to a linear protection switching method and apparatus for protecting a network segmented into multi-domains, and more particularly, to a method and an apparatus for connecting two domains to be protected through a linear protection switching method using two interconnection nodes.

2. Description of the Related Art

A conventional linear protection switching method may protect a physical or a logical connection between two end nodes included in a single protected domain. As illustrated in FIG. 1, which will be provided herein, an end node (E1) may be connected to another end node (E2) through a working path and a protection path. A protection switching process to be performed at each end node may include exchanging information required for the protection switching process through the protection path. A linear protection switching method may enable an exchange of user traffic between two end nodes using an identical path. For example, in a normal state, the two end nodes may exchange the user traffic using the working path. When one of the two end nodes detects a defect on the working path, the two end nodes may exchange the traffic using the protection path by exchanging information therebetween.

### SUMMARY

An aspect of the present invention provides an interconnection node located at an end of a working path and a protection path to connect different adjacent protected domains. The interconnection node may be a working end node located at the end of the working path and a protection end node located at the end of the protection path.

The protection end node may include a receiver to receive, from the working end node located at the end of the working path, path defect information indicating whether a defect occurs on the working path, a processor to perform protection switching in response to reception of the path defect information, and generate path control information used for the working end node to control a connection of the working path based on the protection switching, and a transmitter to transmit the path control information to the working end node.

The processor may control at least one interconnection link connecting the protection end node to at least one node based on the protection switching.

The working end node may include an operation, administration, and maintenance (OAM) unit to detect whether a defect occurs on the working path, a defect information sender to transmit the path defect information generated based on the detection to the protection end node located at the end of the protection path, and a path control information receiver to receive, from the protection end node, the path control information generated based on the protection switching performed by the protection end node using the path defect information.

The working end node may further include a path controller to control at least one interconnection link connecting the working end node to at least one node based on the path control information.

The working end node may further include a defect generation determiner to determine that a defect occurs in a link used to receive the path control information or at the protection end node when the path control information is not received during a predetermined period of time.

Another aspect of the present invention provides an operating method of a protection end node, including receiving, from a working end node located at an end of a working path, path defect information indicating whether a defect occurs on the working path, performing protection switching in response to reception of the path defect information, generating path control information used for the working end node to control a connection of the working path based on the protection switching, and transmitting the path control information to the working end node.

Still another aspect of the present invention provides an operating method of a working end node, including detecting whether a defect occurs on a working path, generating path defect information based on the detecting, transmitting the path defect information to a protection end node located at an end of a protection path, and receiving, from the protection end node, path control information generated based on protection switching performed by the protection end node using the path defect information.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an example of a protected domain using a conventional linear protection switching method;

FIG. 2 is a diagram illustrating an example of a node included in a protected domain using a conventional linear protection switching method;

FIGS. 3 and 4 are diagrams illustrating examples of an interconnection between protected domains according to an embodiment of the present invention;

FIGS. 5A through 5C are diagrams illustrating example types of a link among interconnection nodes connecting protected domains according to an embodiment of the present invention;

FIG. 6 is a diagram illustrating an example of a connection between protected domains according to an embodiment of the present invention;

FIG. 7 is a block diagram illustrating an example of a node performing linear protection switching according to an embodiment of the present invention;

FIGS. 8, 9A, and 9B are diagrams illustrating examples of a node performing linear protection switching according to an embodiment of the present invention;

FIGS. 10A and 10B are flowcharts illustrating linear protection switching according to an embodiment of the present invention; and

FIGS. 11 and 12 are flowcharts illustrating an operation of a node performing linear protection switching according to an embodiment of the present invention.

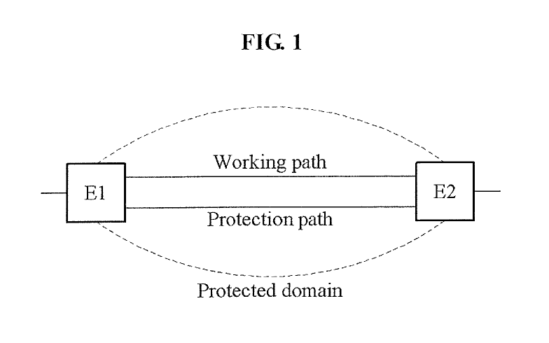

### DETAILED DESCRIPTION

Reference will now be made in detail to example embodiments of the present invention, examples of which are illustrated in the accompanying drawings, wherein like reference numerals refer to the like elements throughout. Example embodiments are described below to explain the present invention by referring to the accompanying drawings, however, the present invention is not limited thereto or restricted thereby.

Example embodiments will now be described more fully with reference to the accompanying drawings in which example embodiments are shown. Example embodiments, may, however, be embodied in many different forms and should not be construed as being limited to the embodiments set forth herein; rather, these example embodiments are provided so that this disclosure will be thorough and complete, and will fully convey the scope of example embodiments to those of ordinary skill in the art. Like reference numerals in the drawings denote like elements, and thus their description may be omitted.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific teams) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

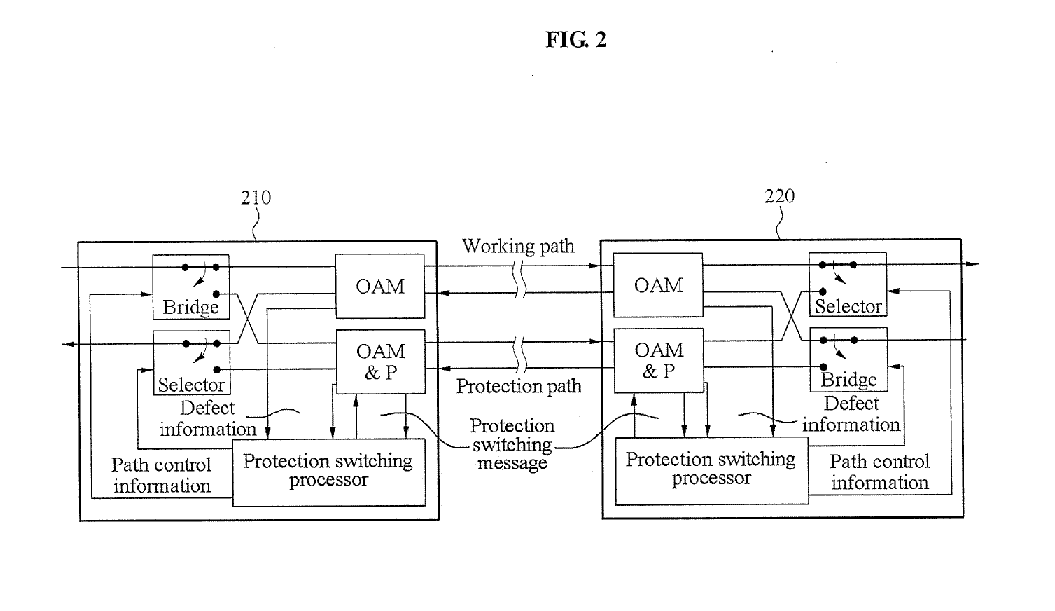

FIG. 2 is a diagram illustrating an example of a node included in a protected domain using a conventional linear protection switching method.

Referring to FIG. 2, nodes, for example, 210 and 220, included in a conventional linear protected domain are located at an end of a working path and a protection path. Thus, the nodes 210 and 220 may also be referred to as end nodes.

Each of the end nodes 210 and 220 includes an operation, administration, and maintenance (OAM) unit and an OAM and protection (OAM & P) unit. The OAM unit may detect a defect on the working path. The OAM & P unit may detect a defect on the protection path, and transmit or receive a protection switching message through the protection path. The end nodes 210 and 220 may use various methods to monitor a state of the working path or the protection path. When defect information including, for example, Signal Fail and Signal Degrade, on the working path and the protection path is provided, the end nodes 210 and 220 may perform a protection switching procedure.

In addition, each of the end nodes 210 and 220 includes a bridge and a selector.

When user traffic flows into the protected domain, the bridge may select a path to be used to transmit the user traffic based on a control by a protection switching processor. The bridge may be a selector bridge that may select any one between the working path and the protection path, and transmit the user traffic through the selected path. Alternatively, the bridge may be a permanent bridge that may transmit the user traffic through the working path and the protection path. The permanent bridge may permanently copy identical traffic and transmit the traffic through the working path and the protection path.

The selector may select any one between the working path and the protection path based on a control, for example, path control information, by the protection switching processor and transmit the user traffic received therethrough to an outside of the protected domain.

In addition, each of the end nodes 210 and 220 includes the protection switching processor. The protection switching processor may perform linear protection switching using defect information on the working path, defect information on the protection path, and a protection switching message received from a corresponding node. The protection switching processor may control the bridge and the selector based on the linear protection switching.

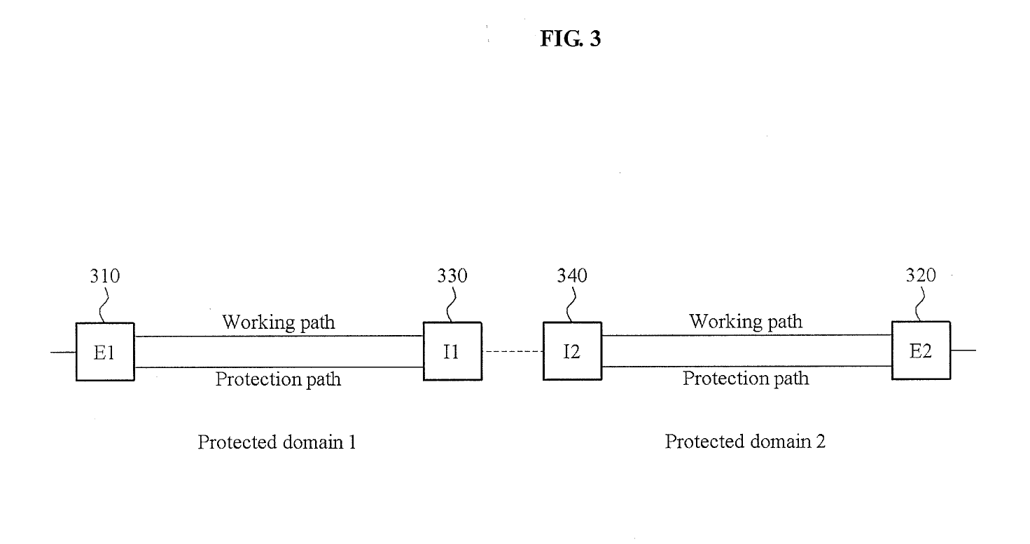

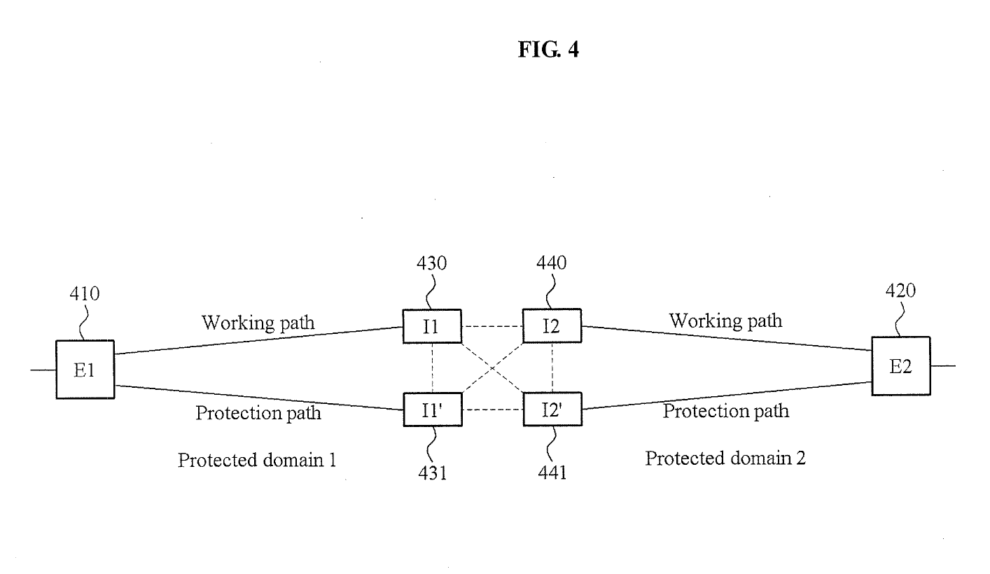

FIGS. 3 and 4 are diagrams illustrating examples of a connection between protected domains according to an embodiment of the present invention.

Referring to FIG. 3, a protected domain is interconnected with a different protected domain through a single node. Thus, FIG. 3 is a diagram illustrating an example of a single-node interconnection.

To provide a service, for example, exchange of user traffic, between an end node (E1) 310 and an end node (E2) 320 included in different protected domains, a protected domain 1 includes an interconnection node (I1) 330, and a protected domain 2 includes an interconnection node (I2) 340. The protected domain 1 and the protected domain 2 are interconnected through the interconnection nodes I1 330 and I2 340. The I1 330 and the I2 340 may be physically distinguishable, or may be a virtual function block that is functionally divided from a single physical node.

The I1 330 and the I2 340 may be connected through a physical interconnection link or a logical interconnection link.

The single-node interconnection method using a single node, for example, a single interconnection node, included in a protected domain may be a simple method to interconnect different protected domains. When the single-node interconnection method is applied, a conventional linear protection switching method may be used as is in each protected domain. In addition, when the single-node interconnection method is applied, the protected domains may be individually protected. However, when a defect occurs at an interconnection node of each protected domains or in a link connecting interconnection nodes, transmission of the traffic between the E1 310 and the E2 320 may be disconnected.

Referring to FIG. 4, a protected domain is interconnected with a different protected domain through a plurality of nodes. Thus, FIG. 4 is a diagram illustrating an example of a dual-node interconnection.

To provide a service between an end node (E1) 410 and an end node (E2) 420 included in different protected domains, a protected domain 1 includes interconnection nodes, for example, I1 430 and I1′ 431, and a protected domain 2 includes interconnection nodes, for example, I2 440 and I2′ 441. Dissimilar to the example of FIG. 3, each of the protected domains of FIG. 4 may include a plurality of interconnection nodes. The I1 430, the I1′ 431, the I2 440, and the I2′ 441 may be physically distinguishable from one another. Alternatively, the I1 430 and the I2 440, or the I1′ 431 and the I2′ 441 may be virtual function blocks that are functionally divided from a single physical node.

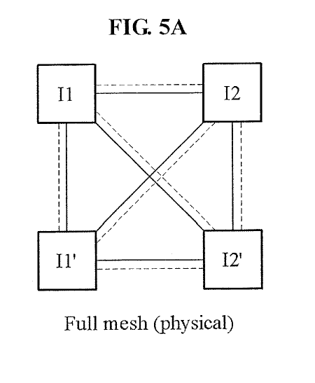

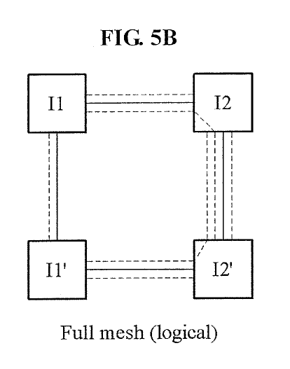

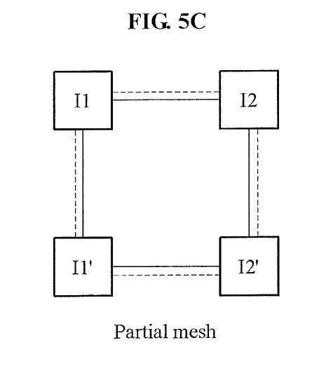

The I1 430, the I1′ 431, the I2 440, and the I2′ 441 may be connected through an interconnection link. The interconnection link will be further described with reference to FIG. 5.

FIGS. 5A through 5C are diagrams illustrating example types of a link among interconnection nodes connecting protected domains according to an embodiment of the present invention.

Based on a configuration of a network, the link among the interconnection nodes may be of a physical full mesh type (refer to FIG. 5A) or a logical full mesh type (refer to FIG. 5B). Also, the link among the interconnection nodes may be of a partial mesh type (refer to FIG. 5C). Alternatively, another type modified from the examples of FIGS. 5A through 5C may exist and thus, the types of the link illustrated in FIGS. 5A through 5C are only an illustrative example.

Referring back to FIG. 4, the dual-node interconnection method using a plurality of nodes included in each protected domain, for example, dual interconnection nodes, to interconnect different protected domains may maintain the connection between the protected domains despite an occurrence of a defect at any one of the interconnection nodes. When the dual-node interconnection method is applied, a conventional linear protection switching method may not be applied as is to each protected domain. In detail, the conventional linear protection switching method may be applicable when an end node on a working path and an end node on a protection path are identical. In the example of FIG. 4, however, the end node on the working path and the end node on the protection node are not identical and thus, the conventional linear protection switching method may not be applicable as is.

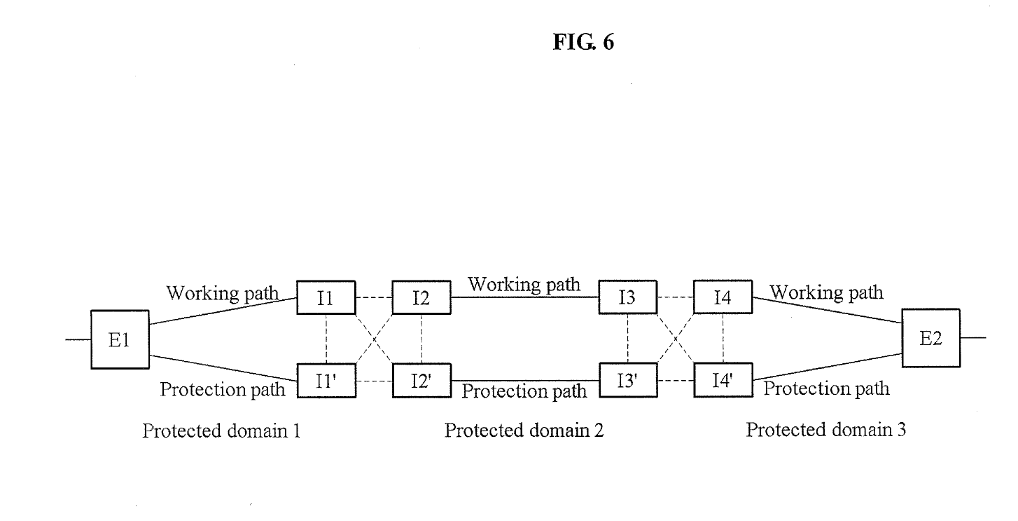

FIG. 6 is a diagram illustrating an example of a connection between protected domains according to an embodiment of the present invention.

Referring to FIG. 6, in a protected domain 2, an end node located at one end of a working path differs from an end node located at one end of a protection path. Also, an end node located at another end of the working path differs from an end node located at another end of the protection path. Thus, in the example of FIG. 6, a conventional linear protection switching method may not be applied as is to all protected domains 1, 2, and 3.

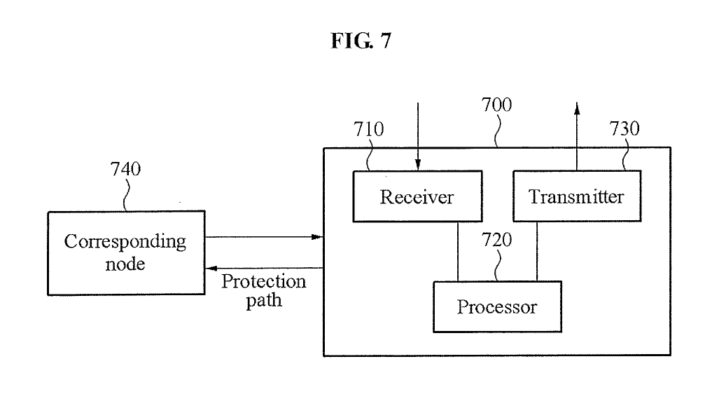

FIG. 7 is a block diagram illustrating an example of a node performing linear protection switching according to an embodiment of the present invention. Hereinafter, an end node located at an end of a working path will be referred to as a working end node, and an end node located at an end of a protection path will be referred to as a protection end node.

Referring to FIG. 7, a protection end node 700 includes a receiver 710, a processor 720, and a transmitter 730.

The receiver 710 receives path defect information from a working end node. The working end node detects whether a defect occurs on a working path. The working end node generates the path defect information based on the detection and transmits the path defect information to the protection end node 700.

The processor 720 performs protection switching in response to reception of the path defect information. The processor 720 generates path control information to be used for the working end node to control a connection of the working path based on the protection switching.

The transmitter 720 transmits the path control information generated by the processor 720 to the working end node.

Although not illustrated in FIG. 7, the protection end node 700 may include at least one interconnection link. The interconnection link may connect the protection end node 700 to at least one node. For example, the interconnection link may connect the protection end node 700 to the working end node. In addition, the interconnection link may connect the protection end node 700 to a protection node and/or a working end node included in a different adjacent protected domain. As described in the foregoing, the interconnection link may be a physical link or a logical link.

The processor 720 controls at least one interconnection link connecting the protection end node 700 to at least one node. For example, when a defect occurs on the working path and user traffic is transmitted through the protection path based on the protection switching, the processor 720 may control the at least one interconnection link. Based on the control by the processor 720, the protection end node 700 may be connected to a protection end node and/or a working end node included in a different adjacent protected domain.

The processor 720 generates a protection switching request message to be transmitted to a corresponding node 740 located at another end of the protection path based on the protection switching. The corresponding node 740 may then perform the protection switching in response to the protection switching request message.

When the path defect information is not received from the working end node during a predetermined period of time, the processor 720 may determine that a defect occurs in a link used to receive the path defect information. Alternatively, when the path defect information is not received from the working end node during the predetermined period of time, the processor 720 may determine that a defect occurs at the working end node.

When at least three end nodes are involved in the protection switching due to different end points on the working path and the protection path, which is dissimilar to a conventional linear protection switching structure in which two end nodes perform the protection switching due to identical end points on the working path and the protection path, nodes at both ends of the protection path may use the conventional linear protection switching method as is. However, an interconnection method, for example, a dual-node interconnection method, may be used to interconnect at least two protected domains to be protected through the linear protection switching method by adding a function of exchanging information required for the protection switching between an end node at which the working path ends and an end node at which the protection path ends.

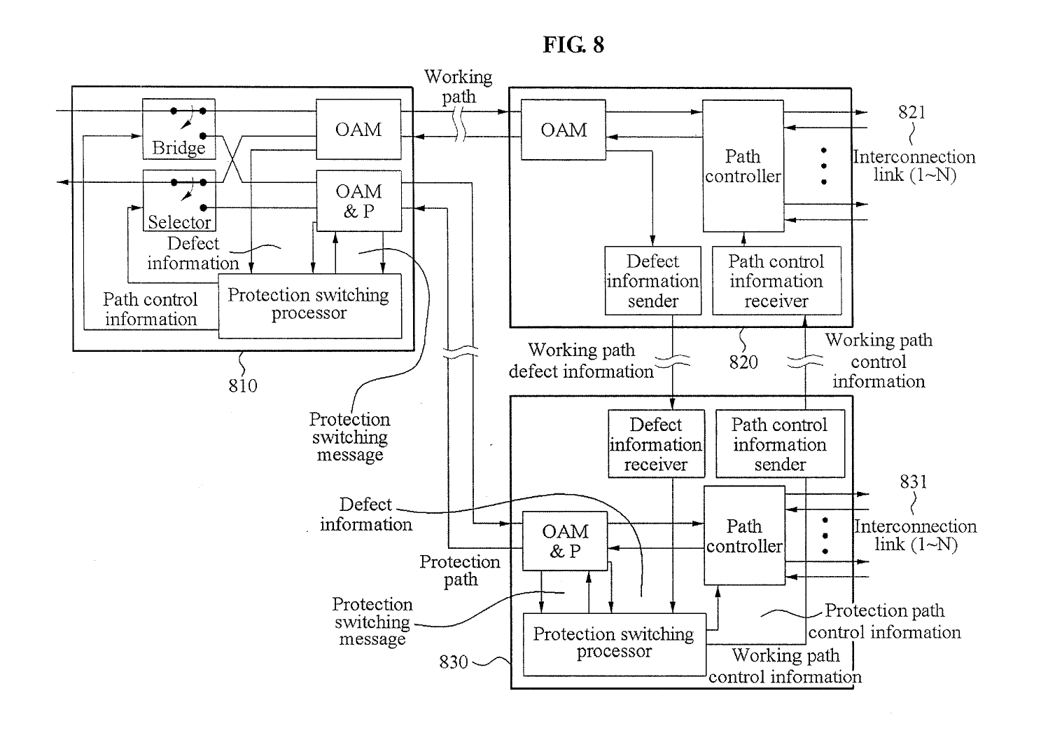

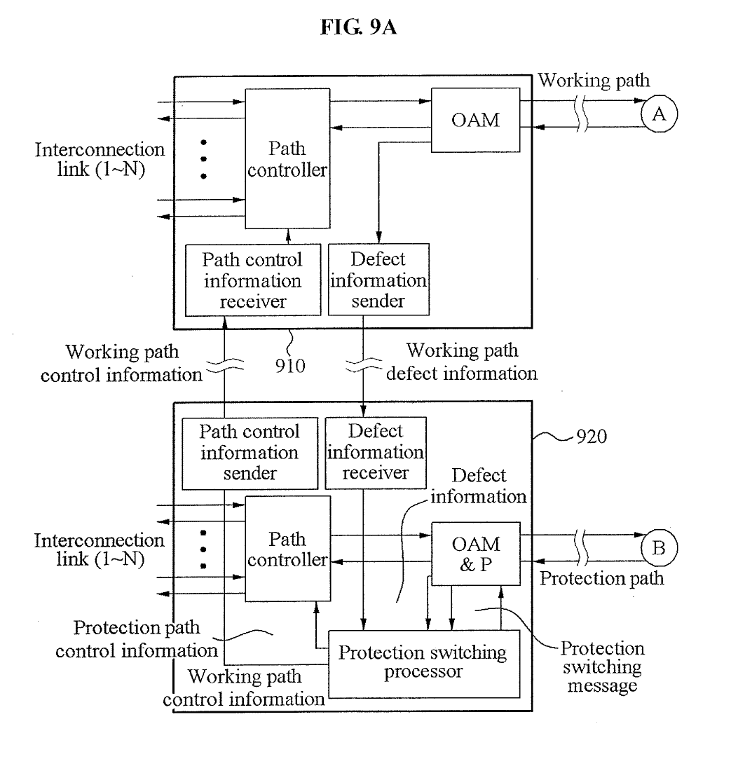

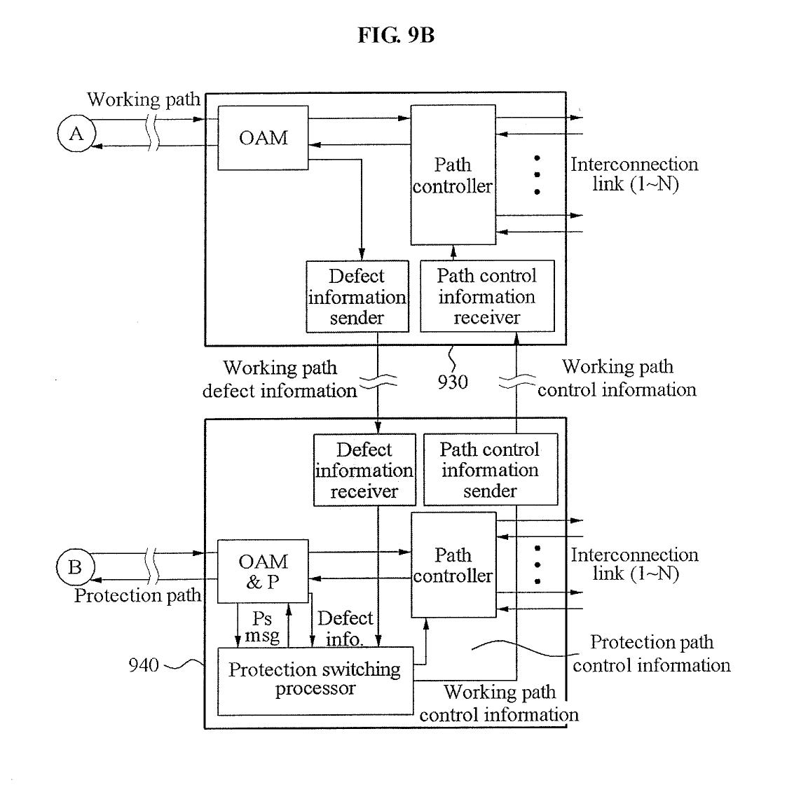

FIGS. 8, 9A, and 9B are diagrams illustrating examples of a node performing linear protection switching according to an embodiment of the present invention.

Referring to FIG. 8, the node performing the linear protection switching includes a working end node 820 and a protection end node 830. The working end node 820 is an end node located at an end of a working path, and the protection end node 830 is an end node located at an end of a protection path.

The working end node 820 and the protection end node 830 may be distinguishable from each other, and include a plurality of interconnection links, for example, 821 and 831. The working end node 820 and the protection end node 830 may be connected to a working end node and/or a protection end node included in a different adjacent protected domain through the interconnection links 821 and 831. The working end node 820 and the protection end node 830 may be connected to each other through the interconnection links 821 and 831. The interconnection links 821 and 831 may be physical links or logical links.

The working end node 820 includes an OAM unit, a defect information sender, a path control information receiver, and a path controller.

The OAM unit monitors a state of the working path.

The defect information sender transmits, to the protection end node 830, defect information on the working path generated based on the state of the working path.

The path control information receiver receives path control information on the working path.

The path controller connects the working path to at least one, for example, the interconnection links 821, of the interconnection links 821 and 831 based on the received path control information. The working path may then be connected to the at least one interconnection links 821 in response to reception of the path control information.

Although not illustrated in FIG. 8, the working end node 820 may further include a defect generation determiner. When the path control information is not received during a predetermined period of time, the defect generation determiner may determine that a defect occurs in a link used to receive the path control information or at the protection end node 830.

The protection end node 830 includes an OAM & P unit, a defect information receiver, a path controller, a path control information sender, and a protection switching processor.

The OAM & P unit monitors a state of the protection path, and transmits a protection switching message to a corresponding node 810 through the protection path or receives the protection switching message from the corresponding node 810.

The defect information receiver receives path defect information generated by the working end node 820.

The path controller connects the protection path to at least one, for example, the interconnection links 831, of the interconnection links 821 and 831 based on a control by the protection switching processor. Based on the control by the protection switching processor, the protection path may then be connected to the at least one interconnection links 831.

The path control information sender transmits, to the working end node 820, path control information generated based on the protection switching.

The path defect information on the working path and the path control information may be periodically exchanged between the working end node 820 and the protection end node 830. The working end node 820 may transmit the path defect information to the protection end node 830 based on a predetermined cycle. Also, the protection end node 830 may transmit the path control information to the working end node 820 based on a predetermined cycle. For example, when new path defect information or new path control information is generated, the new path defect information or the new path control information may be immediately transmitted irrespective of the predetermined cycle. When path defect information or path control information to be transmitted differs from previously transmitted path defect information or previously transmitted path control information, the path defect information or the path control information to be transmitted may be immediately transmitted irrespective of the predetermined cycle.

When the working end node 820 does not receive the path control information from the protection end node 830 during the predetermined period of time, the working end node 820 may determine that the protection end node 830 is malfunctioning. When the working end node 820 does not receive the path control information from the protection end node 830 during the predetermined period of time, the working end node 820 may determine that a defect occurs in a link used to receive the path control information. When distinguishing of the defect at the protection end node 830 and the defect in the link is required, the working end node 820 may receive the path control information using a plurality of links. For example, when the path control information is not received from the links, the working end node 820 may determine that the defect occurs at the protection end node 830.

Similarly, when the protection end node 830 does not receive the path defect information on the working path from the working end node 820 during a predetermined period of time, the protection end node 830 may determine that the working end node 820 is malfunctioning. When the protection end node 830 does not receive the path defect information on the working path from the working end node 820 during the predetermined period of time, the protection end node 830 may determine that a defect occurs in a link used to receive the path defect information. When distinguishing of the defect at the working end node 830 and the defect in the link is required, the protection end node 830 may receive the path defect information using a plurality of inks. For example, when the path defect information is not received from the links, the protection end node 830 may determine that the defect occurs at the working end node 820.

As another example of determining whether a defect occurs at the working end node 820, the protection end node 830 may use a result of detecting a state of the working path by the corresponding node 810 located at an end of the working path. In detail, when the protection end node 830 does not receive the path defect information on the working path from the working end node 820 during a predetermined period of time, but the protection end node 830 receives, from the corresponding node 810, a protection switching message indicating that the working path is in a defect state based on linear protection switching, the protection end node 830 may determine that the working end node 820 is in the defect state.

The protection switching processor included in the protection end node 830 may be located at the working end node 820. The working end node 820 including the protection switching processor controls a selector and a bridge based on a control by the protection switching processor. The protection end node 830 transmits, to the working end node 820, the path defect information on the protection path and the protection switching message received from the corresponding node 810. The path control information may be transmitted from the working end node 820 to the protection end node 830, and the protection switching message generated by the protection switching processor located at the working end node 820 may be transmitted to an end node located at another end of the protection path, for example, the corresponding node 810, through the protection end node 830.

Referring to FIGS. 9A and 9B, an end node located at an end of a working path differs from an end node located at an end of a protection path. Also, an end node located at another end of the working path differs from an end node located at another end of the protection path. The examples of FIGS. 9A and 9B may be similar to the protected domain 2 illustrated in FIG. 6.

Operations of working end nodes 910 and 930 may be identical to operations of the working end node 820 of FIG. 8, and operations of protection end nodes 920 and 940 may be identical to operations of the protection end node 830 of FIG. 8.

Respective protection switching processors included in the protection end nodes 920 and 940 may be located at the working end nodes 910 and 930. The working end nodes 910 and 930 including the protection switching processors may control selectors and bridges based on a control by the protection switching processors. The protection end nodes 920 and 940 may transmit, to the working end nodes 910 and 930, a protection switching message and path defect information on the protection path received from the corresponding protection end nodes 940 and 920 connected to the protection end nodes 920 and 940 through the protection path. Path control information may be transmitted from the working end nodes 910 and 930 to the protection end nodes 920 and 940. The protection switching message generated from the protection switching processors located at the working end nodes 910 and 930 may be transmitted to corresponding end nodes, for example, 940 and 920, at another end of the protection path through the protection end nodes 920 and 940.

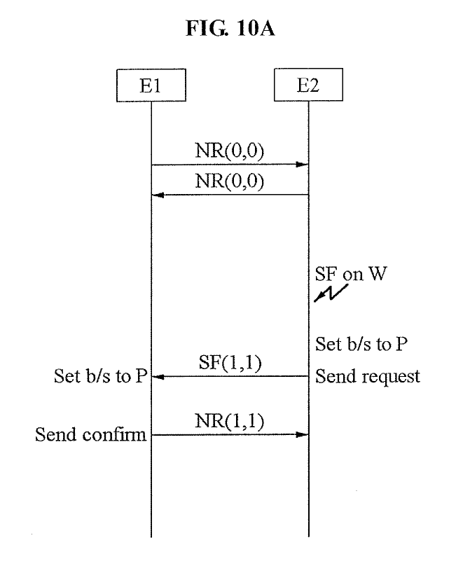

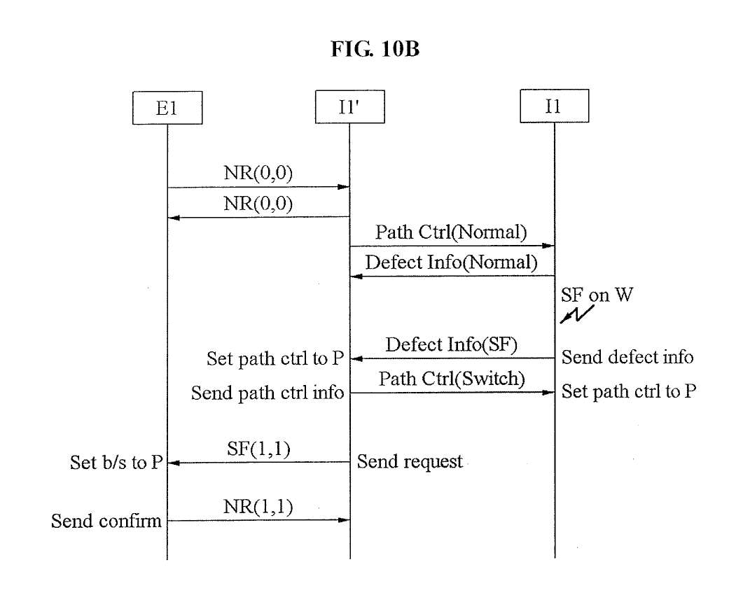

FIGS. 10A and 10B are flowcharts illustrating linear protection switching according to an embodiment of the present invention.

FIGS. 10A and 10B illustrate operations of an end node when a defect occurs on a working path during a protected domain being in a normal state. FIG. 10A is a flowchart illustrating a conventional linear protection switching method, and FIG. 10B is a flowchart illustrating a linear protection switching method according to an embodiment of the present invention.

In FIG. 10A, “NR(0,0), “SF(1,1),” and “NR(1,1)” are protection switching messages stipulated in Ethernet Linear Protection Switching protocol in Recommendation G.8031 by Telecommunication Standardization Sector of International Telecommunication Union (ITU-T). The foregoing protection switching messages are only used as illustrative examples and thus, a protection switching message may not be limited thereto. For example, a protection switching message stipulated in various linear protection switching protocols, for example, Optical Transport Network (OTN) Linear Protection Switching in ITU-T Recommendation G.873.1 and Linear Protection Switching for Multi-protocol Label Switching-Transport Profile (MPLS-TP) in ITU-T Recommendation G.8131. For ease of description, the protection switching message stipulated in the ITU-T Recommendation G.8031 will be described hereinafter as an example.

“N(0,0)” indicates that a node transmitting a message is in a normal state without a protection switching event and is set to exchange traffic through the working path. “SF(1,1)” indicates that a node transmitting a message detects a Signal Failure (SF) on the working path and is set to exchange traffic through the protection path. “NR(1,1)” indicates that a node transmitting a message does not have a protection switching event with a higher priority than a corresponding node and protection switching is completed by a protection switching request from the corresponding node. That is, “NR(1,1)” is a message indicating verification of an “SF(1,1)” message by the corresponding node. In FIG. 10B, “Set b/s to P” indicates connecting a bridge and a selector to the protection path.

As illustrated in FIG. 10A, the protection switching includes exchanging an N(0,0) message between an end node (E1) and an end node (E2) and exchanging traffic through the working path. The protection switching is performed by the E1 and the E2 in the normal state.

When the E2 detects an SF on the working path, the E2 connects the bridge and the selector to the protection path (“Set b/s to P”). The E2 requests the protection switching from the E1 by transmitting the SF(1,1) message to the E1.

When the E1 receives the SF(1,1) message, which is a protection switching request message, from the E2, the E1 connects the bridge and the selector to the protection path (“Set b/s to P”). The E1 then transmits an NR(1,1) message to the E2 to inform the E2 that the protection switching is completed.

When a defect occurs on the working path in the normal state in which the traffic is being exchanged through the working path, a linear protection switching operation may be performed for the traffic to be exchanged through the protection path.

As illustrated in FIG. 10B, the protection switching of the E1 and a protection end node I1′ may be identical to the example of FIG. 10A and thus, the E1 and the I1′ may exchange a protection switching message based on a conventional linear protection switching method.

Since the I1′ may not directly detect path defect information on the working path, the protection switching method according to an embodiment of the present invention may further include receiving the path defect information on the working path from a working end node I1.

In addition, at least one interconnection link included in the I1 and the I1′ may be of various link types based on a configuration of a network as illustrated in FIGS. 5A through 5C. A connection between the working path and at least one interconnection link included in the I1 and a connection between the protection path and at least one interconnection link included in the I1′ may need to be controlled based on a protection switching state of a protected domain. Thus, a protection switching processor in the I1′ may control the connection between the protection path and the at least one interconnection link included in the I1′ based on a result of the linear protection switching operation. Simultaneously, the I1′ may transmit the path control information on the working path to the I1. In addition, the I1 may control the connection between the working path and the at least one interconnection link included in the I1 based on the path control information.

Referring to FIG. 10B, the I1′ transmits path control information (Path Ctrl (Normal)) for the I1 to exchange traffic through the working path in the normal state. The I1 may control a connection between the working path and at least one interconnection link based on the received path control information. In addition, the I1 may transmit, to the I1′, path defect information (Defect Info (Normal)) indicating that no defect occurs on the working path in the normal state. The I1′ may perform linear protection switching operation based on the conventional linear protection switching method.

When the I1 detects an SF on the working path, the I1 may transmit path defect information on the working path (Defect Info (SF)) to the I1′.

The I1′ receiving the path defect information (Defect Info (SF)) may control a connection between the protection path and the at least one interaction link included in the I1′ (“Set path ctrl to P”). Simultaneously with the controlling, the IV may transmit path control information (Path Ctrl (Switch)) to the I1. The I1′ may request protection switching to the E1 by transmitting the SF(1,1) message to the E1. The I1 receiving the path control information from the I1′ may control a connection between the working path and at least one interconnection link (“Set path ctrl to P”).

When the E1 receives the protection switching request message “SF(1,1)” from the I1′, the E1 may perform, identical to the E1 of FIG. 10A, an operation based on the conventional linear protection switching method. That is, when the E1 receives the protection switching request message SF(1,1) from the I1′, the E1 may connect a bridge and a selector to the protection path. The E1 may transmit the NR(1,1) to the I1′ to inform the I1′ that the protection switching is completed.

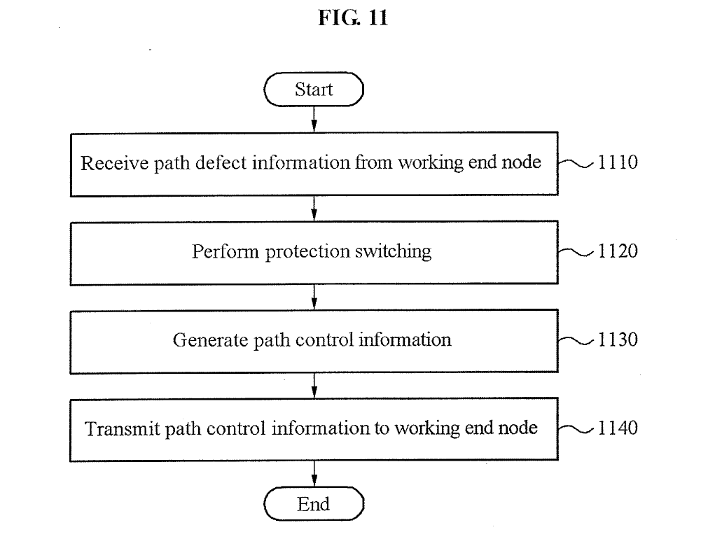

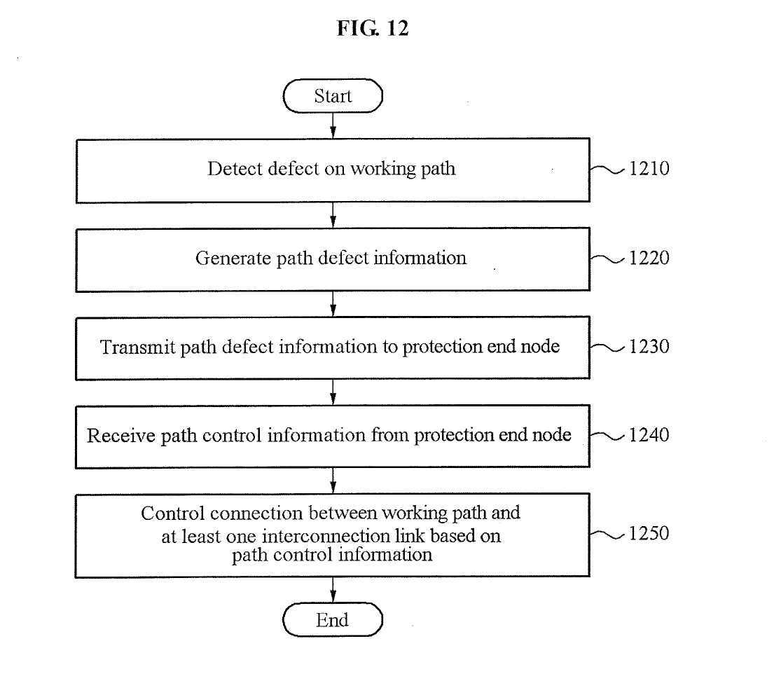

FIGS. 11 and 12 are flowcharts illustrating an operation of a node performing linear protection switching according to an embodiment of the present invention. Accordingly to an embodiment, the linear protection switching may be applicable when an end node on a working path differs from an end node on a protection path. Hereinafter, the end node on the working path will be referred to as a working end node and the end node on the protection path will be referred to as a protection end node.

Referring to FIG. 11, in operation 1110, the protection end node receives, from the working end node, path defect information indicating whether a defect occurs on the working path.

In operation 1120, the protection end node performs protection switching in response to reception of the path defect information. The protection end node may transmit a protection switching request message to a corresponding node located at another end of the protection path for the protection switching to be performed with the corresponding node. The corresponding node may perform the protection switching in response to the protection switching request message. When the protection switching is completed, the corresponding node may transmit, to the protection end node, a message indicating that the protection switching is completed.

In operation 1130, the protection end node generates path control information to be used for the working end node to control a connection of the working path based on the protection switching. In operation 1140, the protection end node transmits the path control information to the working end node.

Based on the protection switching, the protection end node may control at least one interconnection link. The at least one interconnection link may connect the protection end node to at least one node. In detail, based on a result of the protection switching, the protection end node may connect the protection path to the at least one interconnection link. The protection end node may be connected to a node included in a different adjacent protected domain through the at least one interconnection link. For example, the protection end node may be connected to a protection end node and/or a working end node included in a different adjacent protected domain.

When the protection end node does not receive the path defect information during a predetermined period of time, the protection end node may determine that a defect occurs in a link used to receive the path defect information or at the working end node. Here, when the protection end node receives, from a corresponding node located at another end of the protection path, a message indicating that the working path is in a defect state, the protection end node may determine that the defect occurs at the working end node.

When the protection end node does not receive the path defect information through a plurality of links connected between the protection end node and the working end node, the protection end node may determine that the defect occurs at the working end node.

Referring to FIG. 12, in operation 1210, a working end node detects whether a defect occurs on a working path. In operation 1220, the working end node generates path defect information based on the detecting. In operation 1230, the working end node transmits the path defect information to a protection end node.

The protection end node performs protection switching based on the path defect information and generates path control information based on the protection switching. The protection end node transmits the path control information to the working end node. In operation 1240, the working end node receives the path control information.

In operation 1250, the working end node controls a connection between the working path and at least one interconnection link based on the path control information. The at least one interconnection link may connect the working end node to at least one node. The working end node may be connected to a node included in a different adjacent protected domain through the at least one interconnection link. For example, the working end node may be connected to a protection end node and/or a working end node included in a different adjacent protected domain.

When the path control information is not received during a predetermined period of time, the working end node may determine that a defect occurs in a link used to receive the path control information or at the protection end node.

An interconnection node located at an end of the working path and an end of the protection path and connecting different adjacent protected domains may be the working end node located at the end of the working path and the protection end node located at the end of the protection path.

When at least three end nodes perform protection switching because end points of the working path and the protection path are different, which is dissimilar to a conventional linear protection switching structure, end nodes at both ends of the protection path may use the conventional linear protection method as is, and a function of exchanging information required for the protection switching between an end node at which the working path ends and an end node at which the protection path ends may be added. By adding the function, an interconnection method, for example, a dual-node interconnection method, may be provided to interconnect at least two protected domains to be protected through the linear protection switching method according to an embodiment of the present invention.

The units described herein may be implemented using hardware components and software components. For example, the hardware components may include microphones, amplifiers, band-pass filters, audio to digital convertors, and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums. The non-transitory computer readable recording medium may include any data storage device that can store data which can be thereafter read by a computer system or processing device. Examples of the non-transitory computer readable recording medium include read-only memory (ROM), random-access memory (RAM), CD-ROMs, magnetic tapes, floppy disks, optical data storage devices. Also, functional programs, codes, and code segments that accomplish the examples disclosed herein can be easily construed by programmers skilled in the art to which the examples pertain based on and using the flow diagrams and block diagrams of the figures and their corresponding descriptions as provided herein.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A protection end node, comprising:
a receiver configured to receive, from a working end node located at an end of a working path, path defect information indicating whether a defect occurs on the working path;
a processor configured to perform protection switching in response to reception of the path defect information, and generate path control information used for the working end node to control a connection of the working path based on the protection switching; and
a transmitter configured to transmit the path control information to the working end node, and
wherein the protection end node is located at an end of a protection path.

2. The protection end node of claim 1, wherein the processor is configured to control at least one interconnection link connecting the protection end node to at least one node based on the protection switching.

3. The protection end node of claim 1, wherein the processor is configured to generate a protection switching request message to be transmitted to a corresponding node located at another end of the protection path based on the protection switching, and
wherein the corresponding node is configured to perform the protection switching in response to the protection switching request message.

4. The protection end node of claim 1, wherein the protection end node and the working end node are comprised in a protected domain, and configured to connect the protected domain to a different adjacent protected domain.

5. The protection end node of claim 1, wherein, when the path defect information is not received during a predetermined period of time, the processor is configured to determine that a defect occurs in a link used to receive the path defect information or at the working end node.

6. The protection end node of claim 1, wherein the working end node is configured to detect whether a defect occurs on the working path, transmit the path defect information generated based on the detection to the protection end node, and receive, from the protection end node, the path control information.

7. The protection end node of claim 6, wherein the working end node is further configured to control at least one interconnection link connecting the working end node to at least one node based on the path control information.

8. The protection end node of claim 6, wherein the working end node is further configured to determine that a defect occurs in a link used to receive the path control information or at the protection end node when the path control information is not received during a predetermined period of time.

9. An operating method of a protection end node, the method comprising:
receiving, from a working end node located at an end of a working path, path defect information indicating whether a defect occurs on the working path;
performing protection switching in response to reception of the path defect information;
generating path control information used for the working end node to control a connection of the working path based on the protection switching; and
transmitting the path control information to the working end node, and
wherein the protection end node is located at an end of a protection path.

10. The method of claim 9, wherein the protection end node and the working end node are comprised in a protected domain, and configured to connect the protected domain to a different adjacent protected domain.

11. The method of claim 9, wherein the performing of the protection switching comprises:
transmitting a protection switching request message to a corresponding node located at another end of the protection path for the protection switching to be performed with the corresponding node; and
receiving, from the corresponding node, a message indicating that the protection switching is completed.

12. The method of claim 9, further comprising:
controlling at least one interconnection link connecting the protection end node to at least one node based on the protection switching.

13. The method of claim 9, further comprising:
determining that a defect occurs in a link used to receive the path defect information or at the working end node when the path defect information is not received during a predetermined period of time.

14. The method of claim 9, further comprising:
determining that a defect occurs at the working end node when the path defect information is not received through a plurality of links connected between the protection end node and the working end node.

15. The method of claim 9, further comprising:
determining that a defect occurs at the working end node when the path defect information is not received through a link connected between the protection end node and the working end node, and a message indicating that the working path is in a defect state is not received from a corresponding node located at another end of the protection path.

16. An operating method of a working end node, the method comprising:
detecting whether a defect occurs on a working path;
generating path defect information based on the detecting;
transmitting the path defect information to a protection end node located at an end of a protection path; and
receiving, from the protection end node, path control information generated based on protection switching performed by the protection end node using the path defect information, and
wherein the working end node is located at an end of the working path.

17. The method of claim 16, further comprising:
controlling at least one interconnection link connecting the working end node to at least one node based on the path control information.

18. The method of claim 16, further comprising:
determining that a defect occurs in a link used to receive the path control information or at the protection end node when the path control information is not received during a predetermined period of time.
